(19) United States
(12) Patent Application Publication
(10) Pub. No.: US 2009/0249630 A1
(43) Pub. Date: Oct. 8, 2009

(54) Device and Method for Removing the Core of a Plant

(75) Inventors: Kim Deiman, Ijmuiden (NL); Jan Doldersum, Den Haag (NL)

Correspondence Address: THE WEBB LAW FIRM, P.C., 700 KOPPERS BUILDING, 436 SEVENTH AVENUE, PITTSBURGH, PA, 15219, US

(73) Assignee: VACU VIN INNOVATIONS LTD., Queensway, Gibraltar (GB)

(21) Appl. No.: 12/097,648

(22) PCT Filed: Dec. 15, 2006
(86) PCT No.: PCT/NL06/50318

§ 371 Date: Jun. 16, 2008

(30) Foreign Application Priority Data
Dec. 16, 2005 (NL) 1030689

(51) Int. Cl. A47J 25/00; A23N 15/00; B26D 3/26

(52) U.S. Cl. 30/113.3; 30/279.2; 83/27

(57) ABSTRACT

A device and method for removing the core of a plant. This device consists of a tubular part which does not form a completely round circle, but only extends over approximately 180° (i.e. semi-circular arch). This tubular part is provided with a cutting section at one free end, thus making it possible to remove a core part of a plant. On the opposite end, the device is provided with a cutting section which does form a complete continuous circle, thus making it possible to remove an entire core of a plant such as lettuce.

The present invention relates to a device for removing the core of a plant, comprising a tubular part which is provided with an approximately circular cutting section at one free end and a handle section at the other free end.

A device of this type is known from EP 91202833.3 in the name of Vacu Products B.V. and is designed for cutting, for example, a pineapple. Therein the cutting section consists of a serrating extending in a continuous circle and being forced through the core material of the pineapple.

In general, the core of such plants will be removed shortly before consumption. However, there are instances where the user does not intend to eat the entire product. In such a case, once the core part has been removed, an amount of product remains which is not eaten immediately and which has had its core part removed, resulting in a rapid decline in the quality of a product of this type.

It is an object of the present invention to prevent this drawback.

This object is achieved with a device described above in that the tubular part is provided with a lateral opening which extends up to the cutting section which comprises a part of a ring.

According to the present invention, the cutting section does not form a continuous circle, but only a partial circle and more particularly a semicircle. This means that when the user inserts the cutting section into the crop, he can separate part of the core of the crop. This then results in a part in which the cutting section has not cut and a part in which the cutting section has cut. In the first part, for example in half of the plant, the core is then still present and this part can be stored in such a manner that it remains fresh for as long as possible. The other part into which the cutting section has cut no longer has a core (half core) since the latter falls apart when the plant or crop is separated.

A device of this type can be used with all kinds of plants which have a core.

The use with lettuce, cucumbers, spinach and sweet peppers constitutes a specific application. It will be understood that the radius of the circle forming the cutting section will be designed in accordance with the “average” diameter of the core which is to be removed. If appropriate, the cutting section is not exactly circular in design.

In connection with the use with lettuce, a value of 20-30 mm and more particularly of approximately 25 mm is mentioned.

According to a further advantageous embodiment, the handle section also consists of a further cutting section. Unlike the abovementioned cutting section, this further cutting section is indeed designed as a complete continuous circle, thus making it possible to remove a complete core from a plant. That is to say that it is possible to remove the complete core or only part of the core from a plant, as circumstances require.

It will be understood that the first-mentioned cutting section can serve as a handle for the further cutting section. In order to enable optimum handling, the centre axes of the cutting section and further cutting section are at an angle of approximately 90-160°, and more particularly approximately 135°, to one another.

Cutting can be carried out in any manner known from the prior art, but is preferably effected by providing the respective cutting section with teeth. Depending on the hardness of the plant, the device may be made of plastic or, if required, of metal.

The present invention also relates to a method for removing the core of a plant, comprising placing the plant on a carrier, inserting the cutting section of the device as described above and separating the plant after the cut core part has been removed.

The invention will be described in more detail below with reference to an exemplary embodiment illustrated in the drawing, in which:

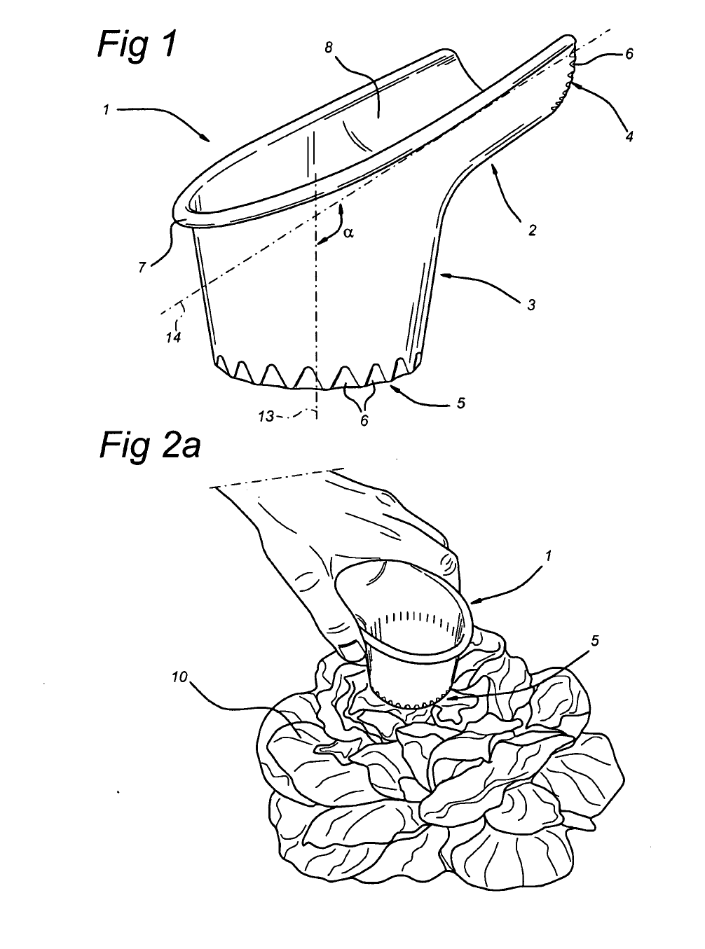

FIG. 1 diagrammatically shows a perspective view of the device according to the invention;

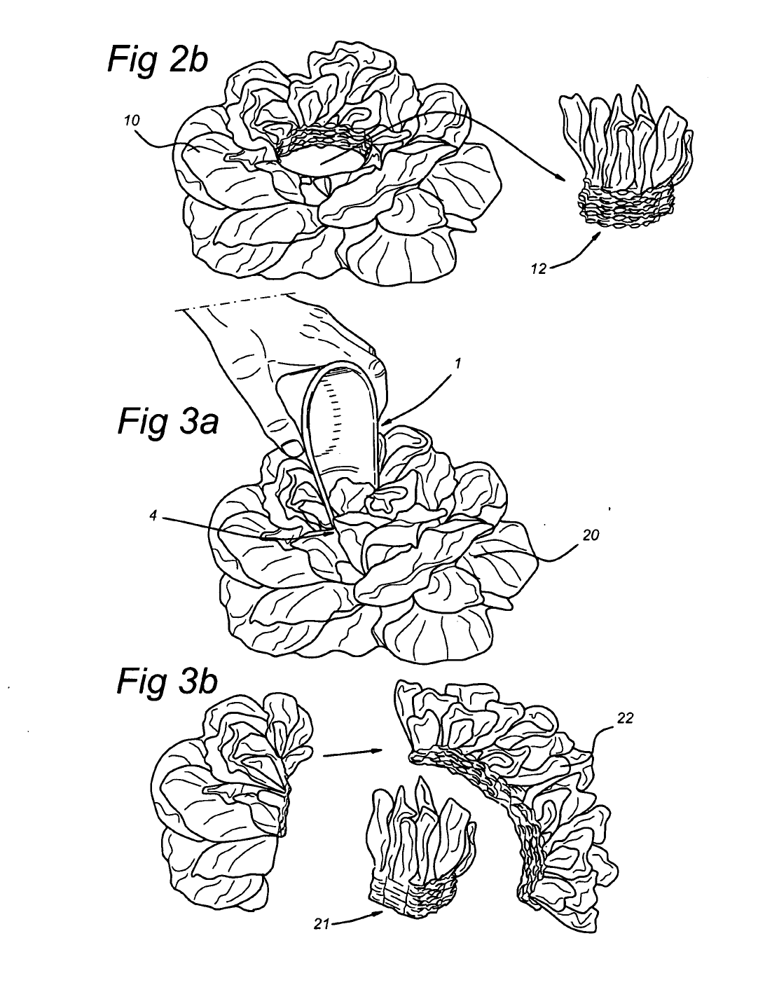

FIGS. 2a, 2b show a first application of the device according to the invention; and

FIGS. 3a, 3b show a second application of the invention.

In the figures, the device according to the invention is denoted overall by reference numeral 1. It consists of a tubular part 2 which is provided with an opening 8. That is to say that the tubular part only extends over a limited part of the circular arch, in the present example approximately 180°. It will be understood that both higher and lower values are possible. The one end of the tubular part is provided with a cutting section 4 with teeth 6. The other end comprises a further tubular part 3 which is provided at its end with a further cutting part 5 with teeth 6. The further tubular part 3 and the further cutting section 5 are indeed designed as a continuous curve (ring).

The centre axis of the cutting section is denoted by reference numeral 14 while the centre axis of the further cutting section is denoted by reference numeral 13. These centre axes are at an angle α of approximately 135°.

The tubular part 2 is provided with a thickening 7 near its free edge.

Both the tubular part 2 and the further tube part 3 taper, preferably conically, in the direction of the respective cutting section 4 and 5, respectively, in order to facilitate the release of the core, which was cut using the latter, and handling of the device.

The device according to the present invention is preferably made of plastic.

FIG. 2 shows a first example of an application of the present invention. Reference numeral 10 denotes a head of lettuce from which the entire core is to be removed. To this end, the further cutting section 5 is pressed into the heart of the head, as can be seen in FIG. 2a. Then, the further cutting section is removed.

This is followed by the removal of the core, as shown in FIG. 2b. The core is denoted by reference numeral 12 and a circular opening appears to have been made in the lettuce, which is now ready for consumption.

In cases where the user does not immediately want to eat the entire head of lettuce, the operation of the device according to FIG. 3 is significant. In this case, the cutting section 4 is pressed into the head 20, as shown in FIG. 3a. Then, the head of lettuce 20 is divided diametrically, which may be carried out after the device 1 according to the invention has been removed. However, it is also possible to do this when the device according to the invention is still present, with the thickened edge 7 providing a guide for the knife.

This then results in the situation shown in FIG. 3b, in which one half of the head of lettuce has not been affected and the other half of the head of lettuce, denoted by reference numeral 22, has had the relevant core 21 removed.

After reading the above description, those skilled in the art will immediately be able to think of variants which fall within the scope of the appended claims. It should be understood that exclusive rights are sought for the variants which are described in the subclaims independent of the main claim.

1-9. (canceled)

10. A device for removing the core of a plant, comprising a tubular part which is provided with an approximately circular cutting section at one free end and a handle section at the other free end, wherein the tubular part is provided with a lateral opening which extends up to the cutting section which comprises a part of a ring, wherein said handle section comprises a further cutting section and said cutting section is designed as a handle for said further cutting section.

11. The device according to claim 10, wherein the lateral opening is designed such that the cutting section is semicircular.

12. The device according to claim 10, wherein the centre axis of said further cutting section is at an angle of 90°-160° to the centre axis of said cutting section.

13. The device according to claim 12, wherein said angle is approximately 135°.

14. The device according to claim 10, wherein the further cutting section is a circular cutting section.

15. The device according to claim 11, wherein the further cutting section is a circular cutting section.

16. The device according to claim 12, wherein the further cutting section is a circular cutting section.

17. The device according to claim 13, wherein the further cutting section is a circular cutting section.

18. The device according to claim 10, wherein the cutting section comprises teeth.

19. The device according to claim 10, wherein the radius of the circle of said cutting section is 20-30 mm.

20. The device according to claim 19, wherein the radius is approximately 25 mm.

21. A method for removing at least a portion of the core of a plant, comprising:
placing the plant on a carrier;
inserting a cutting section of a device for cutting and removing the at least a portion of the core of the plant, wherein the device comprises a tubular part which is provided with an approximately circular cutting section at one free end and a handle section at the other free end, wherein the tubular part is provided with a lateral opening which extends up to the cutting section which comprises a part of a ring, wherein said handle section comprises a further cutting section and said cutting section is designed as a handle for said further cutting section; and
separating the plant after the cut core part has been removed.
